(19) United States
(12) Patent Application Publication
(10) Pub. No.: US 2016/0083275 A1
(43) Pub. Date: Mar. 24, 2016

(54) WATER TREATMENT SYSTEMS AND METHODS

(71) Applicant: Aardvark IP Holding, LLC, Denver, CO (US)

(72) Inventor: David Kolstad, Denver, CO (US)

(21) Appl. No.: 14/617,632

(22) Filed: Feb. 9, 2015

Related U.S. Application Data
(60) Provisional application No. 62/091,358, filed on Dec. 12, 2014.
(60) Provisional application No. 62/052,981, filed on Sep. 19, 2014.
(60) Provisional application No. 62/054,705, filed on Sep. 24, 2014.
(60) Provisional application No. 62/056,936, filed on Sep. 29, 2014.
(60) Provisional application No. 62/060,403, filed on Oct. 6, 2014.

(51) Int. Cl. C02F 1/72; C02F 1/78

(52) U.S. Cl. CPC C02F 1/72; C02F 1/78; C02F 2201/32

(57) ABSTRACT

A water treatment device for treating water in water systems such as cooling towers, evaporative coolers, swimming pools, fountains, sewage wastewater systems, water troughs for agricultural animals, agricultural runoff, and fisheries is described. The water treatment device utilizes a magnetic field, a catalyst, and ultraviolet (UV) radiation to produce a treated gas with increased oxygen radicals to treat a body of water. A mount disposed about a UV lamp may comprise the catalyst material or materials to increase the production of oxygen radicals. The resulting treated gas may be placed in contact with a body of water, for example, to reduce particulate build up, biological matter, and other pollutants.

### CROSS-REFERENCE TO RELATED APPLICATIONS

This application claims priority to U.S. Provisional Patent Application Ser. No. 62/091,358 filed Dec. 12, 2014, U.S. Provisional Patent Application Ser. No. 62/052,981 filed Sep. 19, 2014, U.S. Provisional Patent Application Ser. No. 62/054,705 filed Sep. 24, 2014, U.S. Provisional Patent Application Ser. No. 62/056,936 filed Sep. 29, 2014, and U.S. Provisional Patent Application Ser. No. 62/060,403 filed Oct. 6, 2014, the entire disclosures of which are hereby incorporated herein by reference. This application is also related to U.S. patent application Ser. No. 14/495,702, U.S. Patent Application Publication Nos. 2012/0261349, 2013/0087504, and U.S. Pat. No. 8,361,384, the entire disclosures of which are hereby incorporated herein by reference.

### FIELD

The invention pertains generally to systems and methods for treating water. More particularly, embodiments of the invention utilize systems that expose an oxygen containing gas to magnetic fields, catalysts, and/or a radiation source to form a treated gas, and then deliver the gas to water in order to treat the water.

### BACKGROUND

Water used in various systems can accumulate undesirable content such as particulate matter, bacteria, algae, viruses, fungi, and pollutants. Examples of these water systems include cooling towers, evaporative coolers, swimming pools, fountains, sewage wastewater systems, water troughs for agricultural animals, agricultural runoff, and fisheries. If the undesirable content in these water systems is not treated, it can lead to broken devices, waterborne diseases, and other ill effects.

There are several existing options to treat water systems. For example, chlorination kills biological growth, desalination removes salt, and filtration removes particulate matter. A water system with undesirable content may bleed off water, and the water system is replenished with feed water that does not contain pollution, biological growth, etc. However, the use of chemicals or the constant replenishing of water can substantially increase costs associated with the maintenance of water quality.

Alternative water treatment options such as ultraviolet (UV) lamps can kill biological growth in water. However, UV lamps generally do not help with hyper-concentration and deposition of water-borne solids. Therefore, there is a need for a water treatment system that can function as a disinfectant and reduce the deposition of water-borne solids, while reducing the costs associated with such water treatment.

### SUMMARY

Embodiments of the invention are directed to solving these and other problems and overcoming the disadvantages of the prior art. More particularly, embodiments of the invention provide for the maintenance and improvement of water quality using magnetic fields, catalysts, and radiation to increase oxygen radicals in oxygen containing gas or other gases, and then deliver the treated gas to a body of water or a water containing system.

In accordance with embodiments of the invention, oxygen containing gas is supplied to a water treatment device having a reaction chamber in which at least one magnet, at least one catalytic mount, and at least one UV lamp are disposed. The gas passes through the magnetic field, over the catalytic mount, and through the UV radiation to increase oxygen radicals in the gas, and to form a treated gas. The treated gas is delivered from the water treatment device and is placed in contact with a body of water or a water containing system. The treated gas can reduce particulate matter and disinfect the water.

In accordance with other embodiments of the invention, a mount may have a particular geometry that provides increased surface area for a catalytic material such as nickel. For example, the mount may have a plurality of vanes extending from a central body of the mount. These vanes may form a sweeping incline relative to a top and/or bottom surface of the mount. In addition, the mount may include additional elements that extend from the individual vanes to further increase the surface area of the mount. In various embodiments, the mount may actively or passively rotate to increase the amount of oxygen containing gas that contacts the surface area of the mount. The geometry of the mount may also serve other purposes beyond increased surface area. In some embodiments of the invention, the geometry of the mount provides a location that can receive other components, such as magnets.

In accordance with some embodiments of the invention, magnets may be used to create a magnetic field in a water treatment device. As described above, the mount may comprise a geometry that is adapted to receive magnets. The geometry may be a simple recess in the mount, or the geometry may be more complex such as a protrusion surrounded by an annular recess in the mount. The magnet may be disposed within a recess in the mount. The magnet may also be disposed about a radiation source, for example, a UV lamp. In other words, the magnet may be a ring shape that completely, or partially, encircles the radiation source. Further, more than one magnet may be associated with the mount.

In accordance with exemplary embodiments of the invention, a mount may be disposed at either end of the radiation source. The mounts may interconnect the radiation source to the water treatment device and/or be concentrically disposed about the radiation source. Once a mount and a magnet are disposed about the radiation source, the magnet may abut the mount such that the magnet is at least partially disposed in a recess of the mount. Further, the mount may have recesses on either side to accommodate magnets disposed on either side of the mount. Accordingly, the polarities of two magnets may be oriented such that the magnets are attracted to each other and are secured to the mount via magnetic attraction. In other embodiments, the polarities of two magnets may be oriented such that the magnets are repelled from each other. In these embodiments, the mount may include additional features such as a bayonet fitting to selectively interconnect the magnets to the mount. Various combinations of magnets, mounts, and radiation sources can be used to increase oxygen radicals in oxygen containing gas using magnetic fields, catalysts, and radiation simultaneously, nearly simultaneously, or in series.

Embodiments of the invention may be disposed in a number of support structures. These structures house the water treatment device, including the pump, the reaction chamber, and other components. In some embodiments the support structure is a cabinet where a user may open a door to access the components of the water treatment device. A pump inside of the cabinet draws oxygen containing gas from outside of the cabinet and expels treated gas outside of the cabinet through a conduit. In other embodiments, the water treatment device may only need to treat a body of water or a water containing system that is in a remote location for a short amount of time, and/or it may be desirable to change the location of the water treatment device periodically. Therefore, in some embodiments, the support structure is a trailer or other mobile support structure. It will be appreciated that the trailer may be cabinet-sized and towable behind a light truck or car. In other embodiments, the trailer may be a semi-truck trailer or an intermodal container.

Embodiments of the water treatment device may comprise any number of components alone or in combination. For instance, a water treatment device may have a radiation source with a mount-and-magnet combination disposed at either end of the lamp. In alternative embodiments, a mount-and-magnet combination may simply be disposed at midpoint along the length of the UV lamp. Further yet, a given water treatment device may comprise multiple radiation sources, and multiple water treatment devices may be arranged in parallel or in series to meet the requirements of the overall water treatment system.

One embodiment of the invention is a water treatment device, comprising a reaction chamber at least partially defining an enclosed volume, the reaction chamber having a first end and a second end, wherein an inlet is disposed at the first end of the reaction chamber and an outlet is disposed at the second end of the reaction chamber; a radiation source located within the enclosed volume, the radiation source having a longitudinal length substantially extending from proximate the first end of the reaction chamber to proximate the second end of the reaction chamber; a first mount disposed about the radiation source, the first mount having at least two vanes extending from the first mount, wherein at least a portion of a surface of the first mount comprises a catalyst; and a first magnet disposed about the radiation source and positioned adjacent to the first mount.

In some embodiments, gas enters the enclosed volume through the inlet, moves through a magnetic field generated by the first magnet, passes over the first mount and past the radiation source, and exits the enclosed volume through the outlet. In various embodiments, a second magnet is disposed about the radiation source and positioned adjacent to the first mount, the first magnet having a first polarity and the second magnet having a second polarity, wherein the polarities are oriented such that the first magnet and the second magnet are attracted to each other. In other embodiments, a second magnet is disposed about the radiation source and positioned adjacent to the first mount, the first magnet having a first polarity and the second magnet having a second polarity, wherein the polarities are oriented such that the first magnet and the second magnet are repelled from each other. In some embodiments, a second mount is disposed about the radiation source, the second mount having at least two vanes extending from the second mount, wherein at least a portion of a surface of the second mount comprises a catalyst; a third magnet disposed about the radiation source and positioned adjacent to the second mount; a fourth magnet disposed about the radiation source and positioned adjacent to the second mount, the third magnet having a third polarity and the fourth magnet having a fourth polarity, wherein the polarities are oriented such that the third magnet and the fourth magnet are attracted to each other.

In some embodiments of the invention, the first magnet fully encircles a circumference of the radiation source. In certain embodiments of the invention, at least two vanes form a vane angle with a bottom surface of the first mount, wherein the vane angle is between approximately 30° and 60°. In various embodiments, at least one element extends from each vane of the at least two vanes, wherein the at least one element and each vane of the at least two vanes forms a partially enclosed volume. In some embodiments, the first mount comprises an outer portion rotatably disposed about an inner portion, wherein the at least two vanes extend from the outer portion, and wherein the gas impinges the at least two vanes and causes the outer portion to rotate about the inner portion. In various embodiments, an electric motor operably interconnects to the first mount, wherein excitation of the electric motor causes the first mount to rotate about the radiation source. In some embodiments, the catalyst comprises at least one of nickel, CaNi₅, NaTaO₃:La, K₃Ta₃B₂O₁₂, (Ga_{0.82}Zn_{0.18})(N_{0.82}O_{0.18}), Pt/TiO₂, cobalt, and bismuth.

In embodiment of the invention is a system for treating water, comprising a pump that draws in gas at a first pressure and expels the gas at a second pressure, wherein the second pressure is greater than the first pressure; a first conduit interconnected to the pump, the first conduit channeling the gas from the pump; a first treatment device having an inlet interconnected to the first conduit, the first treatment device comprising a reaction chamber at least partially defining an enclosed volume, the reaction chamber having a first end and a second end, wherein the inlet is disposed at the first end of the reaction chamber and an outlet is disposed at the second end of the treatment chamber; a radiation source located within the enclosed volume, the radiation source having a longitudinal length substantially extending from proximate the first end of the treatment chamber to proximate the second end of the reaction chamber; a first mount disposed about the radiation source, the first mount having at least two vanes extending from the first mount, wherein at least a portion of a surface of the first mount comprises a catalyst; and a first magnet disposed about the radiation source and positioned adjacent to the first mount.

In various embodiments of the invention, a second conduit interconnects to the outlet of the first treatment device, the second conduit channeling the gas from the first treatment device to a water source. In certain embodiments of the invention, a second mount disposed about the radiation source, the second mount having at least two vanes extending from the second mount, wherein at least a portion of a surface of the second mount comprises a catalyst; a third magnet disposed about the radiation source and positioned adjacent to the second mount; a fourth magnet disposed about the radiation source and positioned adjacent to the second mount, the third magnet having a third polarity and the fourth magnet having a fourth polarity, wherein the polarities are oriented such that the third magnet and the fourth magnet are attracted to each other. In various embodiments, a second treatment device has a second inlet interconnected to the first conduit, the second treatment device comprising a second reaction chamber, a second radiation source, a second catalyst, and a fifth magnet. In exemplary embodiments, a second magnet is disposed about the radiation source and positioned adjacent to the first mount, the first magnet having a first polarity and the second magnet having a second polarity, wherein the polarities are oriented such that the first magnet and the second magnet are attracted to each other. In other embodiments, a second magnet is disposed about the radiation source and positioned adjacent to the first mount, the first magnet having a first polarity and the second magnet having a second polarity, wherein the polarities are oriented such that the first magnet and the second magnet are repelled from each other. In some embodiments, the catalyst comprises at least one of nickel, CaNi₅, NaTaO₃:La, K₃Ta₃B₂O₁₂, (Ga_{0.82}Zn_{0.18})(N_{0.82}O_{0.18}), Pt/TiO₂, cobalt, and bismuth.

Another embodiment of the invention is a water treatment device, comprising a support structure; a reaction chamber at least partially defining an enclosed volume, the reaction chamber having a first end and a second end, wherein an inlet is disposed at the first end of the reaction chamber and an outlet is disposed at the second end of the reaction chamber; a radiation source located within the enclosed volume, the radiation source having a longitudinal length that extends from proximate the first end of the reaction chamber to proximate the second end of the reaction chamber; a first mount disposed about the radiation source, the first mount having at least two vanes extending from the mount, the at least two vanes and a bottom surface of the first mount forming a first vane angle; a second mount disposed about the radiation source, the second mount having at least two vanes extending from the second mount, the at least two vanes and a bottom surface of the second mount forming a second vane angle; a plurality of magnets, wherein at least a first magnet in the plurality of magnets is a ring magnet that extends around at least a portion of the radiation source and is held by the first mount, and wherein at least a second magnet in the plurality of magnets is a ring magnet that extends around a second portion of the radiation source and is held by the second mount; and wherein gas enters the enclosed volume through the inlet, passes over the first mount, moves past the radiation source, passes over the second mount, and exits the enclosed volume through the outlet.

Yet another embodiment of the invention is a method for treating water, comprising providing a reaction chamber at least partially defining an enclosed volume, the reaction chamber having a first end and a second end, wherein the inlet is disposed at the first end of the reaction chamber and an outlet is disposed at the second end of the treatment chamber; providing a radiation source located within the enclosed volume, the radiation source having a longitudinal length substantially extending from proximate the first end of the treatment chamber to proximate the second end of the reaction chamber; providing a first mount disposed about the radiation source, the first mount having at least two vanes extending from the first mount, wherein at least a portion of a surface of the first mount comprises a catalyst; providing a first magnet disposed about the radiation source and positioned adjacent to the first mount; supplying oxygen containing gas to the reaction chamber through the inlet; moving the gas through a magnetic field generated by the first magnet, over the first mount, and through radiation generated by the radiation source; and expelling the gas from the reaction chamber through the outlet.

Additional features and advantages of embodiments of the invention will become more readily apparent from the following description, particularly when taken together with the accompanying drawings.

### BRIEF DESCRIPTION OF THE DRAWINGS

FIG. 1 depicts a water treatment system according to an embodiment of the invention;

FIG. 2 is a side cross-section view of components of a water treatment device according to an embodiment of the invention;

FIG. 3 is a side cross-section view of components of a water treatment device according to another embodiment of the invention;

FIG. 4 is a perspective view of a water treatment device housed in a trailer according to an embodiment of the invention;

FIG. 5 is an exploded view of a reaction chamber and associated components according to an embodiment of the invention;

FIG. 6 is a side cross-sectional view of a reaction chamber and associated components according to an embodiment of the invention;

FIG. 7 is a flowchart depicting aspects of a method for treating water according to an embodiment of the invention;

FIG. 8 is a perspective view of a catalyst mount according to an embodiment of the invention;

FIG. 9 is a perspective view of a catalyst mount according to an embodiment of the invention;

FIG. 10 is a perspective view of a catalyst mount according to an embodiment of the invention;

FIG. 11 is a perspective view of a catalyst mount according to an embodiment of the invention; and

FIG. 12 is a cross-sectional view of a catalyst mount according to an embodiment of the invention.

### DETAILED DESCRIPTION

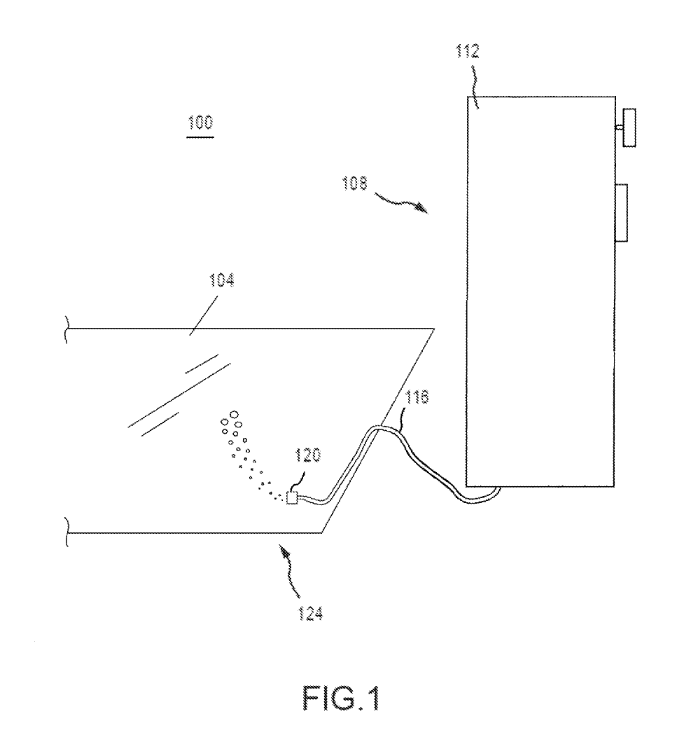

FIG. 1 shows a water treatment system 100 used to treat water 104 in a body of water or a water containing system. A water treatment device 108 is one component of the system 100, and the water treatment device 108 is housed in or associated with a support structure 112, which in this embodiment is a cabinet. The water treatment device 108 draws in an oxygen containing gas, such as ambient air, passes the gas through a reaction chamber to create a treated gas, and supplies the treated gas to an outlet conduit 116. The oxygen containing gas may be subjected to magnetic fields, catalysts, and/or radiation in a reaction chamber of the water treatment device 108 to form the treated gas. The outlet conduit 116 supplies treated gas to an injection port 120, which introduces the treated gas to a body of water 104. In this example, the water 104 is in a swimming pool. However, it will be appreciated that the water treatment system 100 can supply treated gas to water 104 in any body of water or water containing system 124.

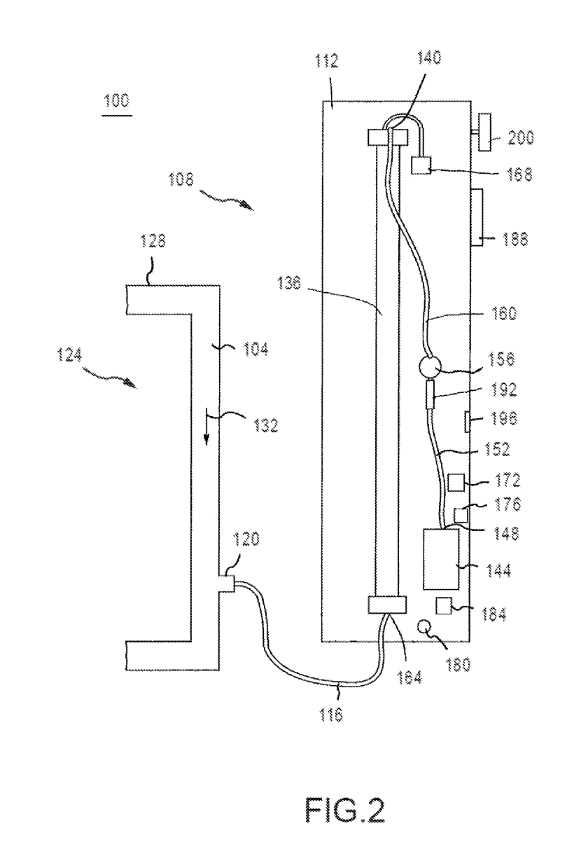

Now referring to FIG. 2, additional components of a water treatment system 100 incorporating a water treatment device 108 in accordance with embodiments of the invention are depicted. In this embodiment, the water treatment device 108 provides treated gas to a water containing system 124 that includes a branch circuit 128 through which water 104 is circulated in the direction of arrow 132. More specifically, treated gas is supplied from the water treatment device 108 by an outlet conduit 116. An injection port 120 is disposed at the end of the outlet conduit 116, and the injection port 120 introduces treated gas to the branch circuit 128 of the water containing system 124. In general, the water treatment device 108 can supply treated gas to any water 104 that benefits from increased oxygen radicals. Examples of water 104 that can be treated using embodiments of the invention include cooling tower water, recreational water, therapy water, architectural water, and agricultural water.

The water treatment device 108 includes a reaction chamber 136 that, as described in detail elsewhere herein, contains at least one radiation source, such as a UV lamp, at least one magnet, and/or at least one mount with a catalyst. Oxygen containing gas is introduced to an inlet 140, for example, by a pump 144 or other source of pressurized gas. The inlet 140 leads to the reaction chamber 136, and the pump 144 delivers oxygen containing gas under positive pressure to the reaction chamber 136 at a desired flow rate. For example, oxygen containing gas can be provided at a flow rate of equal to or greater than 28 liters per hour (L/hr). Flow rates of 300 L/hr or greater may be required for some applications. The pump 144 has a pump outlet 148 that may interconnect to a common supply conduit 152. The pressurized gas moves through the common supply conduit 152, a solenoid 156, and a supply conduit 160 before reaching the inlet 140 of the reaction chamber 136. After exposure to the radiation, the magnetic field, and/or the mount with a catalyst, the oxygen containing gas exits the reaction chamber 136 through an outlet 164 as a treated gas, and is introduced to the water 104 in the water containing system 124.

The water treatment device 108 also includes various electronic components. For example, a ballast 168 may supply a controlled current to the radiation source within the reaction chamber 136. In addition, one or more controller boards 172 may be provided. A controller board 172 can include a processor and associated memory to execute software or firmware to control aspects of the operation of the water treatment device 108. For example, operation of the pump 144, the solenoid 156, and the radiation source can be under the control of the controller board 172. The controller board 172 can also receive control input, for example, from a user through an associated user input device 176 regarding the operation of the water treatment device 108. Moreover, the controller board 172 can provide output to a user output device 180 concerning the operation of the water treatment device 108. In an exemplary embodiment, the controller board 172 may comprise a controller device with an integrated processor and memory. Alternatively or in addition, the controller board 172 can include discrete digital logic devices and/or analog devices. Embodiments of a water treatment device 108 may include various gauges and/or indicator lamps 184 to provide an indication of the proper operation of the radiation source, pump, or other components. For example, a gauge can display the amount of current being drawn by one or more of the radiation sources. As a further example, a gauge or indicator lamp 184 can provide an indication of the pressure within the reaction chamber 136, to provide information regarding the operation of the pump 144. Further, a gauge or indicator lamp 184 may provide an indication of pressure at any point in the water treatment system 100. Alternatively or in addition, the pressure within the reaction chamber 136, or at any point in the system 100, may be displayed on a pressure gauge 188 disposed on the exterior of the cabinet 112.

Additional components may be optionally included in embodiments of the water treatment device 108. For example, the common supply conduit 152 may include a radiator 192 to reduce the temperature of the pressurized gas. A cooling fan 196 may be disposed on an inner surface of the cabinet 112 to also reduce the temperature of the common supply conduit 152 or any other component of the water treatment device 108. A filter 200 may be operably connected to the pump 144 or interior of the cabinet 112 to reduce particulate matter from the oxygen containing gas as it is drawn into the pump 144.

The reaction chamber 136 can be generally cylindrical in shape, having an outer diameter and a length. In some embodiments, the reaction chamber 136 is comprised of UV resistant acrylonitrile butadiene styrene (ABS) plastic or polyvinyl chloride (PVC) material. In other embodiments, the reaction chamber 136 includes materials such as, but not limited to, metal, metal alloys, composites, and natural and synthetic polymers. It will be appreciated that in embodiment with multiple reaction chambers 136, the reaction chambers 136 may not have identical outer diameters, lengths, or material compositions.

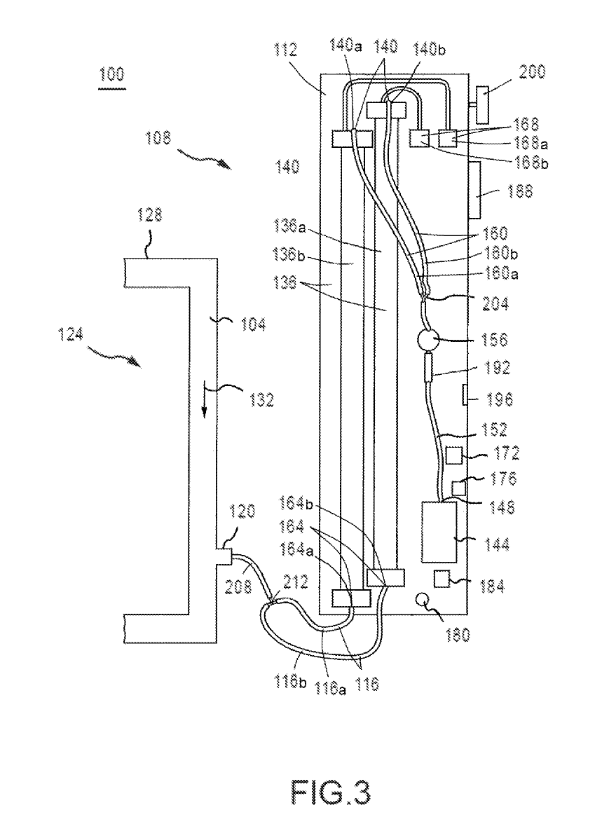

FIG. 3 shows a water treatment device 108 with two reaction chambers 136a, 136b. The water treatment device 108 can include any number of reaction chambers 136, for example, to scale the water treatment device 108 such that an appropriate amount of treated gas can be provided to the water containing system 124. The multiple reaction chambers 136a, 136b may be associated with multiple sets of components (e.g., a first ballast 168a and a second ballast 168a). A pump 144 supplies pressurized gas to inlets 140a, 140b that correspond to each reaction chamber 136a, 136b, respectively. More particularly, pressurized gas moves through the common supply conduit 152 to a Y or T fitting 204 via a solenoid valve 156. First 160a and second 160b supply conduits are interconnected to the first 140a and second 140b inlets of the reaction chambers 136a and 136b, respectively. In accordance with embodiments of the invention, the pump 144 draws oxygen containing gas from the ambient environment, and provides a pressurized supply of such gas to the reaction chambers 136a, 136b. The solenoid valve 156 allows the enclosed volumes of the reaction chambers 136a, 136b to be sealed off while the pump 144 is not supplying pressurized gas, for example, as a result of a planned or inadvertent shutdown of the pump 144, to prevent a backflow of water into the water treatment device 108.

Each reaction chamber 136a, 136b includes an outlet 164a, 164b. Each outlet 164a, 164b can be interconnected to a corresponding outlet conduit 116a or 116b. The outlet conduits 116a or 116b are in turn interconnected to a common outlet conduit 208 by a Y or T fitting 212. The common outlet conduit 208 is interconnected to the branch circuit 128 at an injection port 120. Accordingly, treated gas that has passed through reaction chambers 136a, 136b is supplied to the water 104 within the branch circuit 128 via the injection port 120. In accordance with at least some embodiments, the injection port 120 can comprise a simple T fitting, a bubbler, a venturi, or the like. Alternatively or in addition, the injection port 120 can incorporate or be associated with a one-way valve that allows treated gas to enter the flow of water 104, but to prevent that water 104 from entering the outlet conduit 208. Moreover, the injection port 120 can also incorporate or be associated with a viewing port, for example, to allow maintenance personnel to confirm operation of the device by inspection.

A water treatment device 108 can incorporate more than two reaction chambers 136 through appropriate interconnections of the inlets 140 and outlets 164 of multiple chambers to the pump 144 and the injection port 120, respectively. Multiple reaction chambers 136 may also be arranged in series. In accordance with still other embodiments, a water treatment device 108 can be provided with multiple reaction chambers 136 in which less than all of the reaction chambers 136 are operated. For example, additional reaction chambers 136 can be incorporated as spares, and can be interconnected to the pump 144 and the injection port 120 selectively, for example, after a failure of another one of the reaction chambers 136. In accordance with still other embodiments, a water treatment device 108 with multiple reaction chambers 136 can be provided in which all of the included reaction chambers 136 are interconnected to the pump 144 and to the injection port 120, but in which a selected number of radiation sources associated with reaction chambers 136 are operated at any particular point in time. Such embodiments permit larger amounts of treated gas to be supplied to the injection port 120 when required, by operating all or a greater number of the reaction chambers 136, for example, upon startup of the water treatment device 108 or when aggressive treatment of the water 104 within the water treatment system 100 is desired. When a steady state or when aggressive treatment of the water 104 is not otherwise required, at least some of the radiation sources can be powered off to conserve electrical power.

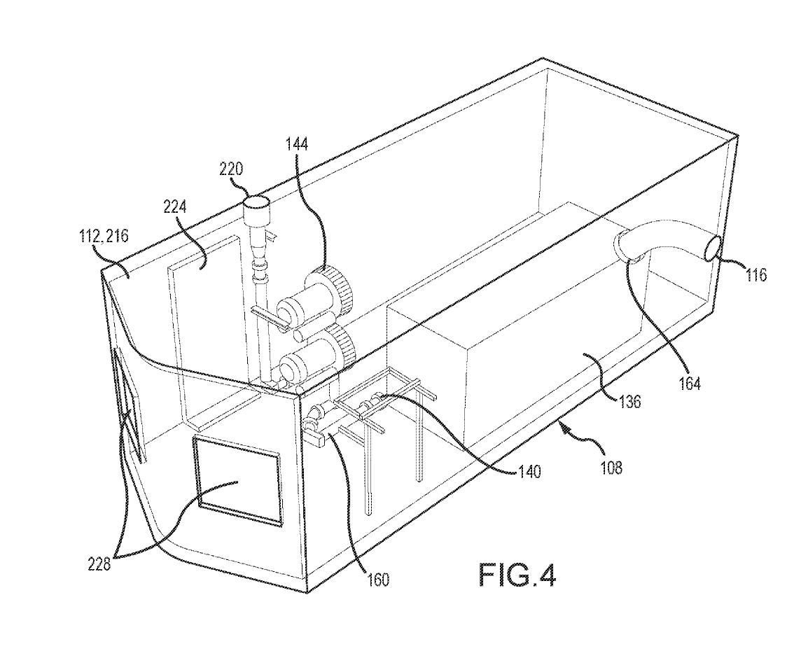

Now referring to FIG. 4, a water treatment device 108 that utilizes a trailer 216 for a support structure 112 is illustrated. Previous embodiments depict the support structure 112 as a cabinet. However, treatment of a body of water or a water containing system 124 may only be a temporary arrangement, and it may be necessary to periodically move the water treatment device 108 to different locations. As for other examples, the treatment of the water 104 within a water containing system 124 may be at a remote location, or it may simply be more convenient to provide a water treatment device 108 as a portable system. Therefore, in some embodiments, a water treatment device 108 as disclosed herein utilizes a trailer 216, sled or other easily moveable assembly for a support structure 112 to provide a portable and/or easily deployed water treatment system 100. The trailer 216 may be similarly sized as a semi-truck trailer or an intermodal container. In other embodiments, the trailer 216 is similarly sized as cabinet embodiments but includes components such as axles, wheels, hitches, etc. to achieve the desired mobility.

The trailer 216 comprises many or all of the same components as the cabinets described elsewhere herein. In FIG. 4, the water treatment device 108 comprises an intake 220 through which oxygen containing gas in the ambient air is drawn from the ambient environment into a pump 144. The intake 220 may comprise components such as a filter to improve the reliability of the various components within the water treatment device 108 by reducing the particulate matter from the oxygen containing gas. The pump 144 pressurizes the oxygen containing gas, which then moves into a supply conduit 160 and then into a reaction chamber 136 via an inlet 140. The oxygen containing gas is subjected to a magnetic field, a catalyst, and/or radiation in the reaction chamber 136. Since the trailer 216 allows for larger scale water treatment devices 108, the reaction chamber 136 may include a number of lamps. For example, embodiments may include 90 UV lamps. Treated gas exits the reaction chamber 136 via an outlet 164 and into an outlet conduit 116 where the treated gas can be delivered to a body of water or a water containing system.

The trailer 216 also comprises other components. For example, the trailer 216 depicted in FIG. 4 comprises a door 224 to allow access inside of the trailer 216 for maintenance and other functions. The trailer 216 also comprises vents 228 that allow for the movement of air between the interior and exterior of the trailer. The vents 228 may be coupled with air blowers to provide an increased movement of air, for example, for cooling and/or the supply of oxygen containing gas to the water treatment device 108.

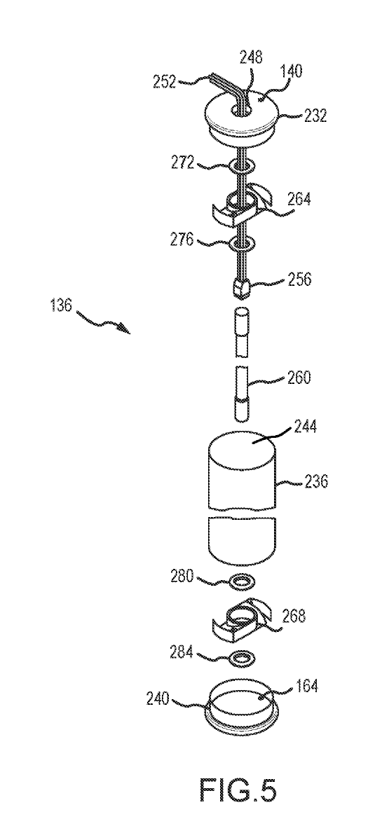

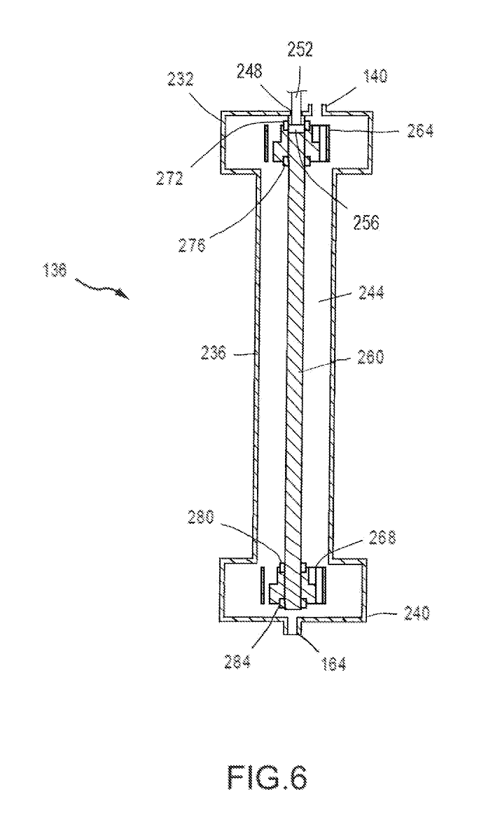

FIGS. 5 and 6 are detailed views of components of a reaction chamber 136 in accordance with embodiments of the invention. In particular, FIG. 5 is an exploded view of an example reaction chamber 136, and FIG. 6 is a cross-sectional view of the reaction chamber 136 of FIG. 5. Referring to both FIGS. 5 and 6, the reaction chamber 136 comprises a first end cap 232, a chamber enclosure 236, and a second end cap 240. Oxygen containing gas enters the first end cap 232 through an inlet 140. The gas flows through an enclosed volume 244 at least partially defined by the chamber enclosure 236, the first end cap 232, and the second end cap 240, and then exits through an outlet 164, which is disposed in the second end cap 240.

The chamber enclosure 236 depicted in FIGS. 5 and 6 has a first end and a second end. The first end cap 232 is selectively interconnected to the chamber enclosure's 236 first end, and the second end cap 240 is selectively interconnected to the chamber enclosure's 236 second end. The selective interconnection between these components may be a screw fitting, a latching fitting, a snap fitting, or any other fitting that non-permanently joins two components. In other embodiments, one or both of the first end cap 232 and the second end cap 240 may be permanently joined with the chamber enclosure 236. Alternatively, the first end cap 232, second end cap 240, and the chamber enclosure 236 may be milled from a single piece of material or otherwise formed as a unitary component.

The first end cap 232 has a conduit aperture 248 for a power conduit 252 to provide power to components located within the enclosed volume 244 of the reaction chamber 136 from an external power source. The power conduit 252 may be any power conduit 252 commonly known in the art. In various embodiments, the power conduit 252 may not require the conduit aperture 248 in the first end cap 232. For example, the power conduit 252 may utilize coupled inductors to transmit power wirelessly. As another example, the power conduit 252 may comprise or be connected to an electrical socket or connector 256 that is connectible from outside of the enclosed volume 244.

The power conduit 252 can pass through the first end cap 232 and can be operably interconnected to an electrical socket 256. A radiation source 260 such as a UV lamp is selectively interconnected to the electrical socket 256 such that the power conduit 252 supplies power to the radiation source 260. Wiring of electrically powered components such as the ballast, pump, and radiation source is not necessarily shown in the figures. However, it will be appreciated that the ballast is wired to the radiation source 260, and that the water treatment device is electrically coupled to a source of electric power in order to operate. Typical electrical coupling includes, but is not limited to, plugging into an electrical outlet or hard-wiring.

The radiation source 260, in some embodiments, can produce UV radiation in a range between approximately 40 nm and 400 nm, wherein “approximately” implies a variation up to +/−10%. For example, the radiation source 260 can comprise a low pressure mercury lamp that produces light at germicidal (e.g., about 254 nm) and ozone producing (e.g., about 185 nm) wavelengths. In at least some embodiments, the radiation source 260 is in the form of a longitudinal tube with first and second ends associated with first and second mounts 264, 268, respectively. The radiation source 260 can be a single ended device in which electrical contacts are provided at one end, or a double ended design, in which electrical contacts are provided at each end.

In some embodiments, the inlet 140 is coaxial with the radiation source 260. In other embodiments, the inlet 140 is not coaxial with the radiation source 260. The distance between the axis of the radiation source 260 and an axis of the inlet 140 is the inlet offset. The outlet 164 may be coaxial with the radiation source 260, or the outlet 164 may comprise an outlet offset similar to the inlet offset described herein.

In the example embodiment of FIGS. 5 and 6, a first mount 264 is adjacent a first end of the radiation source 260 that is selectively interconnected to or that locks to the electrical socket 256, and a second mount 268 is disposed adjacent a second end of the radiation source 260 where the radiation source 260 has electrical contacts at each end so the second mount 268 may also be associated with the electrical socket 256. In some embodiments, one or both of the first mount 264 and the second mount 268 can be nickel plated. The nickel plated first 264 and second 268 mounts function as a catalyst, more particularly a catalyst for forming oxygen radicals. In embodiments of the water treatment device 108 having multiple radiation sources 260 within a reaction chamber 136, multiple pairs of first and second mounts 264, 268 can be provided, and/or each pair of mounts 264, 268 can be associated with multiple radiation sources 260.

The reaction chamber 136 can also include one or more magnets. A first magnet 272 and a second magnet 276 may be disposed about, adjacent, or within the first mount 264 and have their polarities oriented such that the magnets 272, 276 are attracted to each other. Similarly, a third magnet 280 and a fourth magnet 284 may be disposed about, adjacent, or within the second mount 268 and have their polarities oriented such that the magnets 280, 284 are attracted to each other. As a result, magnetic fields that traverse at least some or a substantial portion of the enclosed volume 244 of the reaction chamber 136 are created. Accordingly, oxygen containing gas introduced at the inlet 140 is passed through one or more magnetic fields, as well as being exposed to electromagnetic radiation from the radiation source 260. In accordance with alternative embodiments, the first and second magnets 272, 276 can be arranged such that they repel one another, and the third and fourth magnets 280, 284 can be arranged such that they repel one another. The magnets can comprise permanent magnets, including but not limited to high strength permanent magnets such as neodymium (Neodymium-Iron-Boron) grade N52. Alternatively or in addition, the magnets can comprise electromagnets. In accordance with still other embodiments, magnets can be located outside of the reaction chamber 136, but positioned such that the magnetic field or fields produced by the magnets intersect gas that will be provided to the water.

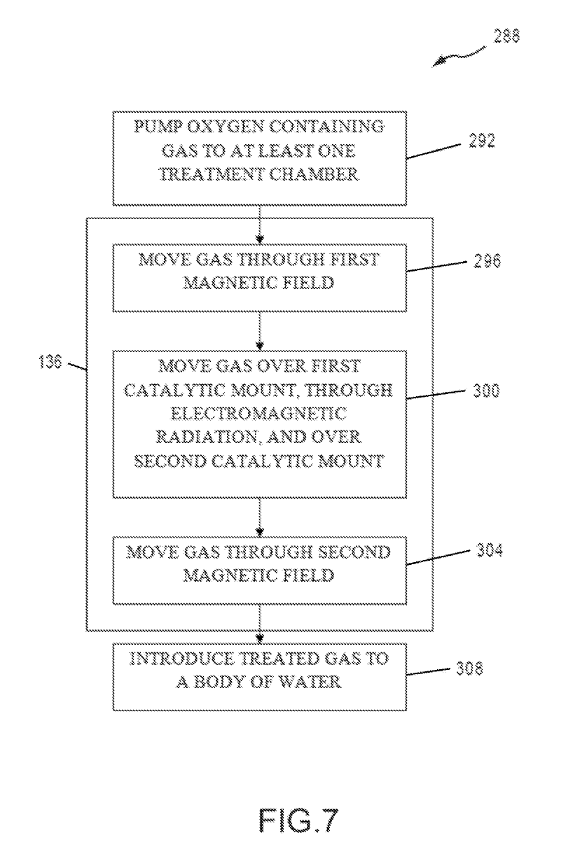

FIG. 7 depicts a process 288 for treating water in accordance with some embodiments of the invention. In step 292, oxygen containing gas is pumped to a reaction chamber 136. The gas can be derived from any source such as, without limitation, the surrounding atmosphere, a compressor, an air pump, or a gas cylinder containing pressurized air to name a few. In some configurations, the gas can comprise an oxygen fortified air or a super-atmospheric oxygen gas stream. Oxygen fortified air generally refers to a gas stream containing more than about 21.1% oxygen (O₂) (according to the 1976 Standard Atmosphere) and nitrogen (N₂), argon (Ar) and carbon dioxide (CO₂) in volume ratio of about 78:1:0.04. At least some of the oxygen contained in the oxygen fortified air can be derived from an oxygen concentrator, oxygen-generator, and/or oxygen source (such as without limitation, bottled oxygen gas or liquid oxygen source). A super-atmospheric oxygen gas stream generally refers a gas stream having a partial pressure of oxygen greater than the ambient oxygen partial pressure. The super-atmospheric oxygen gas stream may or may contain one or more of nitrogen, argon and carbon dioxide and may have a nitrogen:argon:carbon dioxide volume ratio of about 78:1:0.04.

Next, in step 296, the oxygen containing gas passes through a magnetic field generated by a first pair of magnets. The magnets may be permanent magnets, but in some configurations can be electromagnets. In some embodiments of the invention, the magnets in the first pair of magnets are oriented such that the magnets are attracted to each other. In yet further embodiments, the magnets in the first pair of magnets are oriented such that the magnets are attracted to each other. In alternative embodiments, magnets are arranged to the form a linear array with each magnet in the array repelling its nearest neighbors. Stated another way, like magnetic polls positioned adjacent to one another, such as for example (NS) (SN) (NS) (SN).

In step 300 the gas passes over a first catalytic mount, through radiation, and over a second catalytic mount. Embodiments of the invention may comprise one or more mounts to increase the production of oxygen radicals, for example ozone. The mounts have a surface area at least partially comprising a catalyst such as nickel to promote the production of oxygen radicals. As discussed in greater detail below, the geometry of the mounts can enhance the catalytic effect. In some embodiments, the electromagnetic radiation is UV radiation, which can be derived from any process and/or device generating UV radiation such as UV lamps. The gas may absorb at least some the UV radiation to form oxygen radicals. In some configurations, the gas is contacted with the UV radiation in the presence of a magnetic field. In still other embodiments, the gas is contact with the UV radiation in the presence of a magnetic field and in the presence of a catalyst. The UV radiation may comprise radiation having a wavelength of about 185 nm, about 254 nm, or a mixture of 185 and 254 nm wavelengths. As used herein, even lasers and diodes can emit radiation having spectral peaks, although the spectrum or spectrums of radiation may be very narrow. It will be appreciated that even radiation referred to as monochromatic usually emits wavelengths across a spectrum, albeit a very narrow one. Where an electromagnetic radiation source is described as emitting radiation of a specific wavelength or wavelengths, is should be understood that the specific wavelength or wavelengths is considered a spectral peak for the purposes of this specification and appended claims.

The gas also passes over or past a second catalytic mount in step 300. Like the first catalytic mount, the second catalytic mount is at least partially coated or plated with a catalyst such as nickel. However, the gas's composition may change as it passes through the reaction chamber. Therefore, in some embodiments, it is advantageous to have a second catalytic mount with a different geometry, different type of catalyst, different area coated or plated with the catalyst, etc. to optimize production of oxygen radicals in the presence of a different gas composition. It will be appreciated that the two catalysts in this embodiment may also be identical.

In step 304, the gas passes through a second magnetic field generated by a second pair of magnets. In some embodiments, the second pair of magnets is functionally identical to the first pair of magnets. As noted above, however, in some embodiments in may be advantageous to have a second pair of magnets that are different than the first pair of magnets because the gas may change in composition as in steps 296 and 300. Therefore, weaker magnets, stronger magnets, magnets in different combinations, magnets in different locations, etc. may be advantageous. The treated gas exits the reaction chamber into the outlet conduits.

In step 308, the treated gas moves through the outlet conduits and is introduced to a body of water or a water containing system. In some configurations, the water has a first concentration of bacteria and the treated water has a second concentration of bacteria. In some embodiments, the second concentration is no more than the first concentration.

FIGS. 8-12 depict some embodiments of a catalyst plated or coated mount 264 with a shape and surface composition that enhances the production of oxygen radicals such as ozone. For example, the catalyst may be nickel. The mount 264 has a central body 312 surrounded by first and second vanes 316, 320 and first and second elements 324, 328. The central body 312 defines a partially enclosed volume that is generally cylindrical in shape and has an inner diameter. The radiation source 260, or other electromagnetic source, is configured to pass through the partially enclosed volume such that the mount 264 is disposed about the radiation source 260.

A first recess 332 is disposed on one end of the central body 312, and a second recess 336 is disposed on the other end of the central body 312. These recesses 332, 336 have a larger inner diameter than the portion of the central body 312 that partially defines the enclosed volume. The magnets 272, 276, 280, 284 (shown in FIGS. 5 and 6) are configured to be at least partially disposed in the recesses 332, 336 in some embodiments. The magnets 272, 276, 280, 284 are ring shaped so that the magnets 272, 276, 280, 284 and the mount 264 may be disposed about the radiation source 260. Then the magnets 272, 276, 280, 284 may be disposed in the recesses 332, 336 and abut the central body 312 of the mount 264.

The magnets 272, 276, 280, 284 may be arranged in two pairs, and magnets may be disposed on either side of the mount 264. For example, the first and second magnets 272, 276 may be disposed on either side of the mount 264 such that the first magnet is at least partially disposed within the first recess 332, and the second magnet is at least partially disposed within the second recess 336. Furthermore, the first and second magnets 272, 276 may have their polarities oriented such that the magnets 272, 276 are attracted to each other, and thus the first and second magnets 272, 276 are secured to the mount 264 via magnetic attraction. In alternative embodiments, the first and second magnets 272, 276 may have their polarities oriented such that the magnets 272, 276 are repelled from each other. In these embodiments, the magnets 272, 276 may be selectively interconnected to the mount 264 via, e.g., a screw fitting, a bayonet fitting, a latch, etc., to resist the repulsion force.

Next, first and second vanes 316, 320 extend from the outer surface of the central body 312. As shown in FIG. 8, the vanes 316, 320 form a sweeping incline relative to a horizontal or lateral plane. In some embodiments of the invention, the inclined surface of the vanes 316, 320 allow the mount 264 to rotate about or relative to the radiation source 260. For example, the mount 264 may be disposed about a bearing device at an end of the radiation source 260 that allows the mount 264 to rotate freely about an axis corresponding to a longitudinal axis of the radiation source 260. Thus, when gas enters the reaction chamber through the inlet, the gas impinges upon the inclined surface of one or more vanes 316, 320 which causes the mount 264 to rotate. The rotation aids in mixing the gas of the reaction chamber to more evenly distribute the oxygen radicals. Further, the mixing aspect of this embodiment allows more gas to interact with the catalytic area of the mount 264, which increases the production of oxygen radicals.

In some embodiments, the mount 264 may comprise electric contacts to energize the radiation source 260. In further embodiments, the mount 264 uses electric energy to mix the gas in the reaction chamber 136. The mount 264 may be a two piece design where a bearing device and an electric motor allow an outer concentric portion of the mount 264 to actively rotate about an inner portion of the mount 264. This is opposed to other passive embodiments that rely on gas impingement or thermal convection to rotate the mount 264. As the outer portion rotates, the mount 264 arms agitate the gas inside of the reaction chamber 136, which increases the amount of the gas that contacts the mount 264 and is exposed to the radiation source 260.

First and second elements 324, 328 extend from the first and second vanes 316, 320, respectively, and the first and second elements 324, 328 form partially enclosed volumes with the first and second vanes 316, 320, respectively. The additional elements 324, 328 provide more surface area for the mount 264 to interact with the gas, and thus increase production of oxygen radicals.

The surface composition of the mount 264 can enhance the production of oxygen radicals in the gas. As mentioned above, the mounts 264 may be comprised of, or coated with, a material such as nickel. Other catalytic materials include, but are not limited to, CaNi₅, NaTaO₃:La, K₃Ta₃B₂O₁₂, (Ga_{0.82}Zn_{0.18})(N_{0.82}O_{0.18}), Pt/TiO₂, Cobalt-based systems, and Bismuth-based systems. In addition to the mount 264, the reaction chamber 136 or other components of the system 100 may be comprised of, or coated with, a catalytic material to induce the production of the oxygen radicals in the gas.

It will be appreciated that a variety of shapes can be used to increase the surface area of the mount 264 and surface composition that is exposed to gas in the reaction chamber. For example, more than two vanes may be disposed about the central body 312 of the mount 264 where each additional vane increases the surface area of the mount 264. In addition, finned surfaces may be employed to further increase the surface area of the mount 264. Fins may be arrayed in a simple grid-like fashion with longitudinal rows and lateral rows oriented perpendicular to each other, in a more complex three-dimensional pattern, or any other pattern that is commonly known in the art.

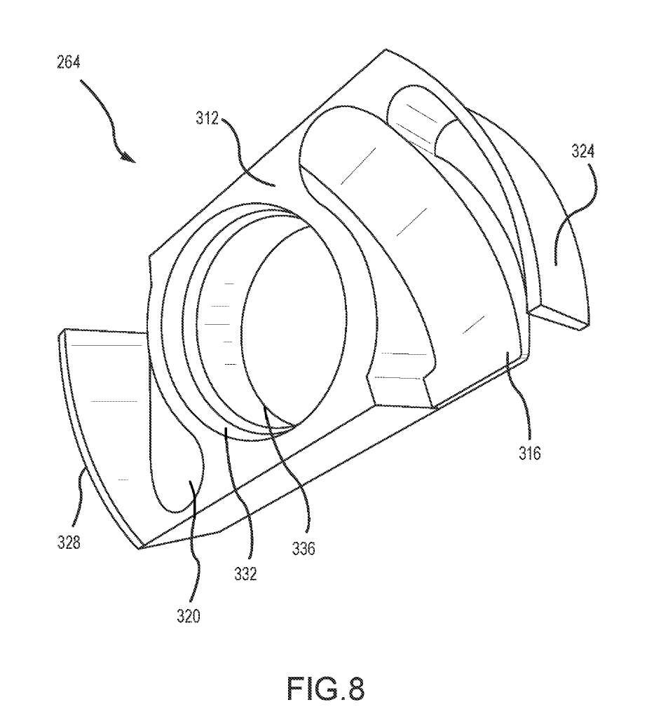

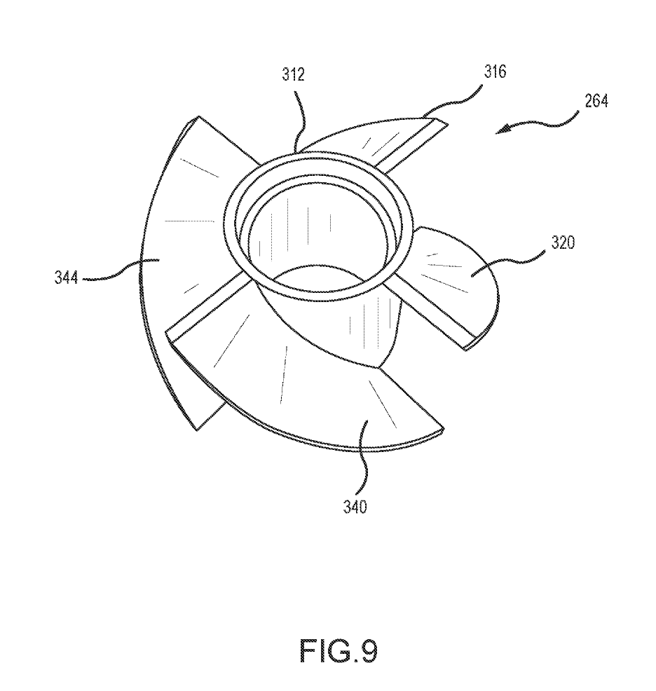

FIG. 9 illustrates an embodiment of the mount 264 with four vanes 316, 320, 340, 344 disposed about the central body 312. The inner surface of each vane is connected to the central body 312 along the entire length of the vane. The ends of the vanes 316, 320, 340, 344 terminate at the top and bottom surface of the central body 312. However, it will be appreciated that the ends of the vanes 316, 320, 340, 344 may run shorter or longer than the surfaces of the central body 312.

The vanes 316, 320, 340, 344 in FIG. 9 generally have an angle relative to the central body 312 of the mount 264. FIG. 9 also shows that when viewed along a longitudinal axis of the mount 264, the vanes slightly overlap each other such that there are no gaps between the vanes. It will be appreciated that other embodiments may comprise gaps between the vanes when viewed along a longitudinal axis of the mount 264.

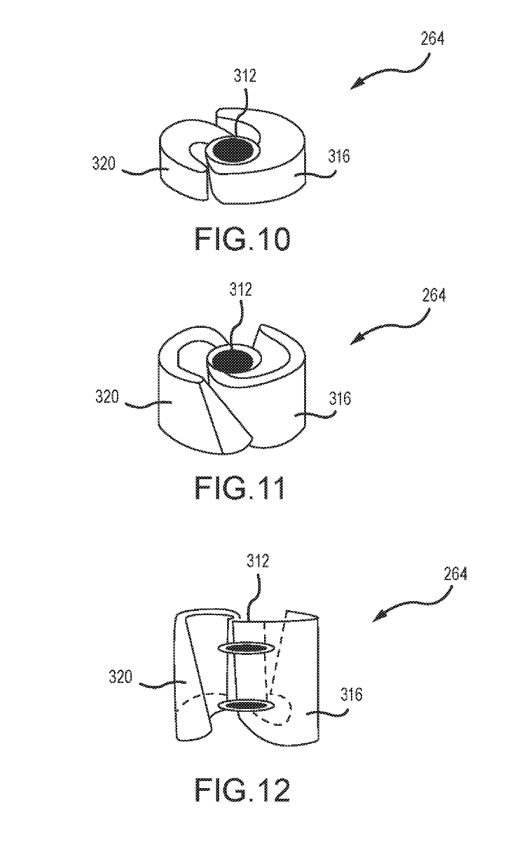

FIGS. 10-12 show other embodiments of a mount 264. FIG. 10 shows a mount 264 with two vanes 316, 320 that extend outward and curl around a central body 312 of the mount 264 in opposing directions. The vanes 316, 320 in this embodiment are not inclined relative to a horizontal plane, a lateral plane, a top surface of the central body 312, or a bottom surface of the central body 312.

FIG. 11 shows a mount 264 that is taller in the longitudinal direction of the radiation source than the mount 264 depicted in FIG. 10. This elongation of the mount 264 further increases its surface area, particularly in the direction of the gas flow. FIG. 11 also shows that the ends of the mount 264 vanes are not perpendicular to the top and/or bottom surfaces of the mount 264. Instead, the ends of the vanes taper to a point, which exposes more surface area toward the radiation source for increased production of oxygen radicals.

FIG. 12 is a cross-section view of the mount 264 of FIG. 11 taken along a longitudinal plane. This cross-section view shows that the inner surfaces of the vanes also comprise a taper or angle that increases the surface area of the mount 264 that is exposed to the moving gas for increased production of oxygen radicals.

It will be appreciated that embodiments of the invention are not limited to particular dimensions. However, dimensions of some exemplary water treatment system components are provided. In some embodiments, the reaction chamber's outer diameter is between approximately 2.5 cm and 31 cm. In various embodiments, the reaction chamber's outer diameter is between approximately 3.5 cm and 9.0 cm. In a certain embodiment, the reaction chamber's outer diameter is approximately 3.8 cm, and in another embodiment, the reaction chamber's outer diameter is approximately 8.9 cm. Further, the reaction chamber's length is between approximately 30 cm and 178 cm. In various embodiments, the reaction chamber's length is between approximately 66 cm and 102 cm. In certain embodiments, the reaction chamber's length is approximately 66 cm, 76 cm, 91.5 cm, 96.5 cm, or 101.5 cm.

Exemplary arrangements or orientations of various components are also provided. In various embodiments, the inlet offset between the inlet to the reaction chamber and the radiation source is between approximately 0.25 cm and 30.5 cm. In other embodiments, the inlet offset is between approximately 0.5 cm and 15.5 cm. In certain embodiments, the inlet offset is between approximately 1 cm and 5.5 cm. In some embodiments, the inlet offset is approximately 1.2 cm.

In some embodiments, this vane angle between the vane and one of the top or bottom surface of the central body of the mount is between approximately 5° and 60°. In various embodiments, the vane angle is between approximately 15° and 45°. In some embodiments, the vane angle is approximately 30°. In other embodiments, this vane angle is between approximately 30° and 60° from the bottom surface of the mount 264. In a further embodiment, the vane angle is approximately 45° from the bottom surface of the central body. In some embodiments, the vanes taper at a vane angle between approximately 30° and 60° from the bottom surface of the mount. In a further embodiment, the vane angle is approximately 45° from the bottom surface of the mount. In some embodiments, the inner surfaces of the vanes are angled between approximately 60° and 90° from the bottom surface of the mount. In a further embodiment, the inner surface is angled approximately 75° from the bottom surface of the mount.

In addition to exemplary dimensions and orientations, exemplary components are provided. As an example, without limitation, the pump 144 may be a Tetra Whisper® 150 aquarium air pump. In addition, a non-limiting example of a ring magnet is a 1.9 cm×1.3 cm×3.2 cm neodymium ring magnet. The ring magnets comprising each pair of magnets are placed about 0.6 cm apart with poles opposing each other. A magnetic field perpendicular to the lamp is generated by the opposing poles of each pair of magnets. Moreover, the magnetic field generated by each pair of magnets passes directly across the corona of the lamp positioned with the void of the ring magnets.

The neodymium magnets have a residual induction (Br) from about 12.9 to about 13.3 KGauss and about 1.29 to about 1.33 Tesla, a minimum coercive force from about 1.5 to about 12.4 K-Oersted and from about 915 to about 987 kA/m, a minimum intrinsic coercive force Hci from about 12 to about 25 K-Oersted and from about 955 to about 1,592 kA/M, and maximum energy product (BH) max from about 40 to about 43 MGOe and from about 318 to about 342 kJ/m3

In accordance with exemplary embodiments of the invention, a radiation source such as a UV lamp can produce UV radiation with multiple wavelengths in a water treatment device. The UV lamp may produce a first wavelength that is within a range of from about 178 nm to about 187 nm to produce oxygen radicals such as ozone gas, and the UV lamp may produce a second wavelength that is within a range from about 252 nm to about 256 nm, which is highly antimicrobial. The radiation source 260 may also be a G36T5VH/4P (manufactured by USHIO America, Inc., a subsidiary of USHIO Inc. of Japan) ozone producing quartz UV lamp, with a main spectral peak at approximately 253.7 nm and another spectral peak at approximately 185 nm. The G36T5VH/4P ozone producing quartz UV lamp is generally elongate and cylindrical, having a length of about 84 cm and a diameter of about 1.5 cm. It uses a universal B224PWUV-C ballast. The G36T5VH/4P lamp consumes approximately 40 watts power and emits approximately 14 watts power in the form of UV radiation.

Other embodiments comprise other radiation sources, including, but not limited to, other UV lamps, lasers, or diodes adapted to emit radiation in the UV range. Some embodiments do not require a ballast, or use a different ballast than the B224PWUV-C. Non-limiting examples of suitable lamps include arc, discharge (including noble gas, sodium vapor, mercury vapor, metal-halide vapor or xenon vapor), induction, plasma, low-pressure, high-pressure, incandescent and discharge lamps emitting UV radiation having suitable wavelengths. Examples of suitable lasers, without limitation, include gas, chemical, excimer, solid-state, fiber, photonic, semi-conductor, dye or free-electron laser operate in one of continuous or pulsed form. Furthermore, suitable diodes include without limitation are diamond, boron nitride, aluminum nitride, aluminum gallium nitride, and aluminum gallium, indium nitride.

In some embodiments, the radiation source or the magnets reside outside the reaction chamber. In these embodiments, the chamber enclosure 236 permits transmission of substantial amounts of radiation from the radiation source 260 into a reaction chamber 136. For example, a glass tube comprising GE Type 214 fused quartz glass is an appropriate chamber enclosure 236 where the radiation source resides outside the reaction chamber 136.

Moreover, the radiation source 260 can, in an exemplary embodiment, but without limitation, comprise a four pin single ended device with pins or electrical contacts. It will be appreciated that in a single-ended lamp, the power is supplied to an electrode or electrodes at one end of the radiation source 260 by wires that extend from the first end to the second end of the radiation source 260. In accordance with a further example embodiment, the radiation source 260 can be a double ended device, with electrical contacts at each end. In accordance with still other embodiments, the radiation source 260 can comprise any source of radiation at the desired wavelength or wavelengths. For example, a radiation source 260 can comprise one or more lasers tuned or otherwise configured to output a desired wavelength or wavelengths.

Next, embodiments with exemplary performance results are provided. In at least some embodiments, the nickel plated mounts 264, 268 can improve the efficiency of forming oxygen radicals by at least about 10%, more commonly by at least about 25%, or even more commonly by at least about 50%. Moreover, the nickel plated mounts 264, 268 typically improve the effectiveness of the treated gas used to treat water by at least about 10%, more typically by at least about 25%, or even more typically by at least about 50%. Moisture (characterized as relative humidity “RH” in Table I below) in the gas can affect the catalytic process. The first 264 and second 268 mounts may be nickel plated by an electroless plating process. The nickel plating may be nickel phosphorous alloy having from about 4 to about 7 wt % phosphorous. The nickel plating has a thickness from about 7.62 micro meters to about 12.7 micro meters.

Table I below summarizes the improvement realized by moving the gas over a nickel plated mount in the reaction chamber. The scenarios where the mount was nickel plated realized an increase in production of oxygen radicals, as measured by an ozone meter. Furthermore, the level of water vapor in the gas can enhance the efficiency and effectiveness of the conversion of oxygen containing gas to treated gas with addition oxygen radicals.

TABLE I

| | PPM Oxygen Radicals Produced* | | | |
|---|---|---|---|---|
| | Without Ni | Without Ni | With Ni | With Ni |
| Feed Gas | Catalyst | Catalyst | Catalyst | Catalyst |
| Liters/Min | (15% RH) | (40% RH) | (15% RH) | (40% RH) |
| 5 | 14.2 | 14.3 | 16.9 | 18.8 |
| 10 | 12.3 | 12.6 | 14.4 | 17.2 |
| 15 | 9.1 | 9.1 | 10 | 10.7 |
| 20 | 5.4 | 5.4 | 6 | 6.3 |

*as measured by an ozone meter.

Embodiments of the invention comprise water treatment devices that utilize a magnetic field, a mount having a catalyst, radiation, and/or oxygen containing gas to produce gas that can be used to treat water, including but not limited to solute-laden water, highly alkaline water, and biologically contaminated water, or water that will likely become highly alkaline or biologically contaminated in the absence of treatment. An example of such water is cooling tower water. Other examples include, but are not limited to oil or gas well by-product water and other contaminated water generated as a by-product of an industrial process or processes. Embodiments of the invention are also effective at treating swimming pool water and spa or hot tub water, where the water treatment devices typically stabilize chlorine concentration, and reduce the need for chlorine in the water.

By use of the water treatment device, the pH of solute laden water such as cooling tower water can be modulated, and biological contamination is highly controlled without the use of, or with substantially reduced use of, chemical agents. Water treatment costs are therefore reduced by use of the water treatment device over chemical treatment alone. Embodiments of the invention effectively treat cooling tower water by preventing or eliminating biological contamination of the water, and by lowering pH about 0.2 units, or maintaining cooling tower water pH 0.2 units below what the pH would be if the cooling tower water were untreated.

Embodiments of the water treatment device disclosed herein can mitigate total alkalinity such that alkalinity does not concentrate as fast as calcium ions, water hardness, chloride ions, conductivity, or other indices of cycles of concentration. In a typical installation, total alkalinity is 50%-75% of expected based on cycles of concentration indicated by an increase in chloride ion concentration. The reduced alkalinity can be highly beneficial, with deposition of scale and other mineral deposits on cooling tower parts being greatly reduced or eliminated completely. Embodiments of the water treatment device disclosed herein can operate to decrease calcium concentration where the water treatment device is installed on a cooling water system that has incurred substantial mineral deposits. In many cases, the substantial mineral deposits can be substantially or completely eliminated. The substantial mineral deposits are typically eliminated within a year of installing the water treatment device.

In some embodiments, the water treatment device includes a glass media filter. The filter can remove or reduce suspended solids, including dead bacteria, and may help prevent infestation of water with Legionella bacteria.

In some embodiments, the water treated by the water treatment device is cooling tower water. The cooling tower water may be a re-circulated cooling tower water, typically referred to as a closed dry cooling tower water. While not wanting to be limited by example, the cooling tower water may be a component of an oil refinery, a petrochemical and/or other chemical plant, a power station or a heating, ventilation and air condition system. The water treatment device can be configured to introduce treated gas at any location in the cooling water system. The treated gas may be contacted with water that is injected in the cooling tower header line and/or side stream line interconnected to the cooling tower header line.

In some embodiments, the water treated by the water treatment device is one of recreational, therapy and architectural water. The recreational, therapy and/or architectural waters may comprise a re-circulating water system. Non-limiting examples of recreational waters include swimming pools, spas and hot tubs. Non-limiting examples of therapy pools include hydrotherapy pools, injury (such as, burn, skeletal, and/or muscular) recovery/rehab pools, low impact exercise pools and such. Architectural waters include without limitation water fountains, water walls, reflective pools and the like. The water re-circulating system for recreational, therapy and architectural waters typically include one or more of the following unit operations: balance tank unit; flocculation process; filtration unit; aeration unit; antimicrobial treatment unit; and sorbent treatment unit. The water treatment device can be configured to contact treated gas with the recreational, therapy and/or architectural water at any location in the re-circulating water system. The water treatment device can replace one or more of the unit operations, such as but not limited to the aeration and antimicrobial units.

In some embodiments, the water treated by the water treatment device is agricultural water. The water may contain an adjuvant being applied to animal and/or plant to treat the animal and/or plant. In some embodiments, the adjuvant is formulated with water treated by the water treatment device. In some embodiments, the water containing the adjuvant is treated by the water treatment device prior to being applied to the animal and/or plant.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A water treatment device, comprising:
a reaction chamber at least partially defining an enclosed volume, the reaction chamber having a first end and a second end, wherein an inlet is disposed at the first end of the reaction chamber and an outlet is disposed at the second end of the reaction chamber;
a radiation source located within the enclosed volume, the radiation source having a longitudinal length substantially extending from proximate the first end of the reaction chamber to proximate the second end of the reaction chamber;
a first mount disposed about the radiation source, the first mount having at least two vanes extending from the first mount, wherein at least a portion of a surface of the first mount comprises a catalyst; and
a first magnet disposed about the radiation source and positioned adjacent to the first mount.

2. The device of claim 1, wherein gas enters the enclosed volume through the inlet, moves through a magnetic field generated by the first magnet, passes over the first mount and past the radiation source, and exits the enclosed volume through the outlet.

3. The device of claim 1, further comprising:
a second magnet disposed about the radiation source and positioned adjacent to the first mount, the first magnet having a first polarity and the second magnet having a second polarity, wherein the polarities are oriented such that the first magnet and the second magnet are attracted to each other.

4. The device of claim 1, further comprising:
a second magnet disposed about the radiation source and positioned adjacent to the first mount, the first magnet having a first polarity and the second magnet having a second polarity, wherein the polarities are oriented such that the first magnet and the second magnet are repelled from each other.

5. The device of claim 1, further comprising:
a second mount disposed about the radiation source, the second mount having at least two vanes extending from the second mount, wherein at least a portion of a surface of the second mount comprises a catalyst;
a third magnet disposed about the radiation source and positioned adjacent to the second mount;
a fourth magnet disposed about the radiation source and positioned adjacent to the second mount, the third magnet having a third polarity and the fourth magnet having a fourth polarity, wherein the polarities are oriented such that the third magnet and the fourth magnet are attracted to each other.

6. The device of claim 1, wherein the first magnet fully encircles a circumference of the radiation source.

7. The device of claim 1, wherein the at least two vanes form a vane angle with a bottom surface of the first mount, wherein the vane angle is between approximately 30° and 60°.

8. The device of claim 1, further comprising:
at least one element extending from each vane of the at least two vanes, wherein the at least one element and each vane of the at least two vanes forms a partially enclosed volume.

9. The device of claim 1, wherein the first mount comprises an outer portion rotatably disposed about an inner portion, wherein the at least two vanes extend from the outer portion, and wherein the gas impinges the at least two vanes and causes the outer portion to rotate about the inner portion.

10. The device of claim 1, further comprising:
an electric motor operably interconnected to the first mount, wherein excitation of the electric motor causes the first mount to rotate about the radiation source.

11. The device of claim 1, wherein the catalyst comprises at least one of nickel, CaNi₅, NaTaO₃:La, K₃Ta₃B₂O₁₂, (Ga_{0.82}Zn_{0.18})(N_{0.82}O_{0.18}), Pt/TiO₂, cobalt, and bismuth.

12. A system for treating water, comprising:
a pump that draws in gas at a first pressure and expels the gas at a second pressure, wherein the second pressure is greater than the first pressure;
a first conduit interconnected to the pump, the first conduit channeling the gas from the pump;
a first treatment device having an inlet interconnected to the first conduit, the first treatment device comprising:
a reaction chamber at least partially defining an enclosed volume, the reaction chamber having a first end and a second end, wherein the inlet is disposed at the first end of the reaction chamber and an outlet is disposed at the second end of the treatment chamber;
a radiation source located within the enclosed volume, the radiation source having a longitudinal length substantially extending from proximate the first end of the treatment chamber to proximate the second end of the reaction chamber;
a first mount disposed about the radiation source, the first mount having at least two vanes extending from the first mount, wherein at least a portion of a surface of the first mount comprises a catalyst; and
a first magnet disposed about the radiation source and positioned adjacent to the first mount.

13. The device of claim 12, further comprising:
a second conduit interconnected to the outlet of the first treatment device, the second conduit channeling the gas from the first treatment device to a water source.

14. The device of claim 12, further comprising:
a second mount disposed about the radiation source, the second mount having at least two vanes extending from the second mount, wherein at least a portion of a surface of the second mount comprises a catalyst;
a third magnet disposed about the radiation source and positioned adjacent to the second mount;
a fourth magnet disposed about the radiation source and positioned adjacent to the second mount, the third magnet having a third polarity and the fourth magnet having a fourth polarity, wherein the polarities are oriented such that the third magnet and the fourth magnet are attracted to each other.

15. The device of claim 12, further comprising:
a second treatment device having a second inlet interconnected to the first conduit, the second treatment device comprising a second reaction chamber, a second radiation source, a second catalyst, and a fifth magnet.

16. The device of claim 12, further comprising:
a second magnet disposed about the radiation source and positioned adjacent to the first mount, the first magnet having a first polarity and the second magnet having a second polarity, wherein the polarities are oriented such that the first magnet and the second magnet are attracted to each other.

17. The device of claim 12, further comprising:
a second magnet disposed about the radiation source and positioned adjacent to the first mount, the first magnet having a first polarity and the second magnet having a second polarity, wherein the polarities are oriented such that the first magnet and the second magnet are repelled from each other.

18. The device of claim 12, wherein the catalyst comprises at least one of nickel, CaNi₅, NaTaO₃:La, K₃Ta₃B₂O₁₂, (Ga_{0.82}Zn_{0.18})(N_{0.82}O_{0.18}), Pt/TiO₂, cobalt, and bismuth.

19. A water treatment device, comprising:
a support structure;
a reaction chamber at least partially defining an enclosed volume, the reaction chamber having a first end and a second end, wherein an inlet is disposed at the first end of the reaction chamber and an outlet is disposed at the second end of the reaction chamber;
a radiation source located within the enclosed volume, the radiation source having a longitudinal length that extends from proximate the first end of the reaction chamber to proximate the second end of the reaction chamber;
a first mount disposed about the radiation source, the first mount having at least two vanes extending from the mount, the at least two vanes and a bottom surface of the first mount forming a first vane angle;
a second mount disposed about the radiation source, the second mount having at least two vanes extending from the second mount, the at least two vanes and a bottom surface of the second mount forming a second vane angle;
a plurality of magnets, wherein at least a first magnet in the plurality of magnets is a ring magnet that extends around at least a portion of the radiation source and is held by the first mount, and wherein at least a second magnet in the plurality of magnets is a ring magnet that extends around a second portion of the radiation source and is held by the second mount; and
wherein gas enters the enclosed volume through the inlet, passes over the first mount, moves past the radiation source, passes over the second mount, and exits the enclosed volume through the outlet.

20. A method for treating water, comprising:
providing a reaction chamber at least partially defining an enclosed volume, the reaction chamber having a first end and a second end, wherein the inlet is disposed at the first end of the reaction chamber and an outlet is disposed at the second end of the treatment chamber;
providing a radiation source located within the enclosed volume, the radiation source having a longitudinal length substantially extending from proximate the first end of the treatment chamber to proximate the second end of the reaction chamber;
providing a first mount disposed about the radiation source, the first mount having at least two vanes extending from the first mount, wherein at least a portion of a surface of the first mount comprises a catalyst;
providing a first magnet disposed about the radiation source and positioned adjacent to the first mount;
supplying oxygen containing gas to the reaction chamber through the inlet;
moving the gas through a magnetic field generated by the first magnet, over the first mount, and through radiation generated by the radiation source; and
expelling the gas from the reaction chamber through the outlet.
